(19) United States
(12) Patent Application Publication
(10) Pub. No.: US 2026/0220595 A1
(43) Pub. Date: Jul. 30, 2026

(54) PICK-OUT ASSISTANCE DEVICE, PICK-OUT ASSISTANCE SYSTEM, PICK-OUT ASSISTANCE METHOD, AND NON-TRANSITORY COMPUTER-READABLE MEDIUM

(71) Applicant: NEC Corporation, Tokyo (JP)

(72) Inventors: Yaeko YONEZAWA, Tokyo (JP); Syunsuke YAMAMOTO, Tokyo (JP); Yuji TAHARA, Tokyo (JP); Soma SHIRAISHI, Tokyo (JP); Naohiro HAYASHI, Tokyo (JP); Ryosuke SAKAI, Tokyo (JP); Tomokazu KANEKO, Tokyo (JP); Takami SATO, Tokyo (JP); Azusa NAGASAWA, Tokyo (JP)

(73) Assignee: NEC Corporation, Tokyo (JP)

(21) Appl. No.: 19/145,963

(22) PCT Filed: Mar. 29, 2023
(86) PCT No.: PCT/JP2023/012723

§ 371 Date: Jul. 7, 2025

(51) Int. Cl. G06Q 10/087; G06Q 30/0202

(52) U.S. Cl. CPC G06Q 10/08724; G06Q 30/0202

(57) ABSTRACT

A pick-out assistance device is provided with: a commodity determination unit that determines one or more second commodities that are different from first commodities and that are displayed within a prescribed range from the display location of the first commodities designated as commodities to be displayed on a commodity shelf; a number determination unit that determines the number of the first commodities to be displayed and the number of each of the one or more second commodities to be displayed; and a notification unit that notifies an operator of the number of the first commodities to be displayed and the number of each of the one or more second commodities to be displayed.

### TECHNICAL FIELD

The present disclosure relates to a pick-out assistance device, a pick-out assistance system, a pick-out assistance method, and a non-transitory computer-readable medium.

### BACKGROUND ART

In recent years, a technology for supporting a pick-out operation for displaying commodities on a commodity shelf in a store has been developed. For example, Patent Literature 1 describes a commodity management system that transmits a replenishment request for a commodity to a portable wireless communication terminal carried by a store clerk in a case where the number of commodities displayed on a commodity shelf falls below a predetermined number.

### CITATION LIST

### Patent Literature

Patent Literature 1: Japanese Unexamined Patent Application Publication No. 2009-205482

### SUMMARY OF INVENTION

### Technical Problem

In a case where the store clerk arranges the commodities on the commodity shelf, a plurality of types of commodities may be arranged at respective display locations. In such a case, when the display locations of the commodities are distant from each other, a distance the store clerk moves becomes long, and the efficiency is poor.

An example object of the present disclosure is to provide a pick-out assistance device, a pick-out assistance system, a pick-out assistance method, and a non-transitory computer-readable medium capable of improving the efficiency of the pick-out operation.

### Solution to Problem

According to a first example aspect of the present disclosure, there is provided a pick-out assistance device including: a commodity determination means that determines one or more second commodities that are different from first commodities and that are displayed within a prescribed range from a display location of the first commodities designated as commodities to be displayed on a commodity shelf; a number determination means that determines the number of the first commodities to be displayed and the number of each of the one or more second commodities to be displayed; and a notification means that notifies an operator of the number of the first commodities to be displayed and the number of each of the one or more second commodities to be displayed.

According to a second example aspect of the present disclosure, there is provided a pick-out assistance system including: a pick-out assistance device that assists an operator in a pick-out operation; and a terminal device that is used by the operator, in which the pick-out assistance device includes a commodity determination means that determines one or more second commodities that are different from first commodities and that are displayed within a prescribed range from a display location of the first commodities designated as commodities to be displayed on a commodity shelf, a number determination means that determines the number of the first commodities to be displayed and the number of each of the one or more second commodities to be displayed, and a notification means that notifies the terminal device of the number of the first commodities to be displayed and the number of each of the one or more second commodities to be displayed.

According to a third example aspect of the present disclosure, there is provided a pick-out assistance method including causing a computer to: determine one or more second commodities that are different from first commodities and that are displayed within a prescribed range from a display location of the first commodities designated as commodities to be displayed on a commodity shelf; determine the number of the first commodities to be displayed and the number of each of the one or more second commodities to be displayed; and notify an operator of the number of the first commodities to be displayed and the number of each of the one or more second commodities to be displayed.

According to a fourth example aspect of the present disclosure, there is provided a non-transitory computer-readable medium storing a program that causes a computer to execute: processing of determining one or more second commodities that are different from first commodities and that are displayed within a prescribed range from a display location of the first commodities designated as commodities to be displayed on a commodity shelf; processing of determining the number of the first commodities to be displayed and the number of each of the one or more second commodities to be displayed; and processing of notifying an operator of the number of the first commodities to be displayed and the number of each of the one or more second commodities to be displayed.

### Advantageous Effects of Invention

It is possible to provide a pick-out assistance device, a pick-out assistance system, a pick-out assistance method, and a non-transitory computer-readable medium capable of improving the efficiency of the pick-out operation.

### BRIEF DESCRIPTION OF DRAWINGS

FIG. 1 is a block diagram illustrating a configuration of a pick-out assistance device according to a first example embodiment.

FIG. 2 is a diagram illustrating a configuration of a pick-out assistance system according to a second example embodiment.

FIG. 3 is a flowchart illustrating an example of a pick-out assistance method according to the second example embodiment.

FIG. 4 is a diagram illustrating an example of an acquired image according to the second example embodiment.

### EXAMPLE EMBODIMENT

Hereinafter, example embodiments of the present disclosure will be described in detail with reference to the drawings. In the drawings, the same or corresponding elements are denoted by the same reference numerals, and repeated description is omitted as necessary for clarity of description.

### First Example Embodiment

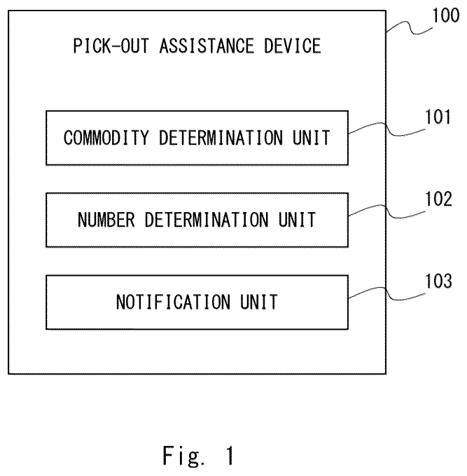

FIG. 1 is a block diagram illustrating a configuration of a pick-out assistance device 100 according to a first example embodiment. The pick-out assistance device 100 assists in an operation (hereinafter, also referred to as “pick-out”) in which an operator such as a store clerk picks out commodities from a warehouse of a store and arranges the commodities on a commodity shelf in a store. For example, as illustrated in FIG. 1, the pick-out assistance device 100 includes a commodity determination unit 101, a number determination unit 102, and a notification unit 103.

The commodity determination unit 101 is also referred to as a commodity determination means. The commodity determination unit 101 determines one or more second commodities that are different from first commodities and that are displayed within a prescribed range from the display location of the first commodities designated as commodities to be displayed on a commodity shelf. Here, the first commodities are commodities in which a ratio of the number of actually displayed commodities to the number of commodities to be displayed is equal to or less than a prescribed ratio among the commodities displayed on the commodity shelf. In other words, the first commodities mean commodities that need to be replenished among the commodities displayed on the commodity shelf. The second commodities are commodities to be replenished or displayed in a case where the first commodities are replenished on the commodity shelf. For example, the second commodities are commodities displayed within a prescribed range from the display location of the first commodities, and the number of actually displayed commodities is smaller than the number of commodities to be displayed.

The number determination unit 102 is also referred to as a number determination means. The number determination unit 102 determines the number of first commodities to be displayed and the number of each of the one or more second commodities to be displayed.

The notification unit 103 is also referred to as a notification means. The notification unit 103 notifies an operator of the number of first commodities to be displayed and the number of each of the one or more second commodities to be displayed. Specifically, the notification unit 103 transmits, to a terminal device used by the operator, the number of first commodities to be displayed and the number of each of the one or more second commodities to be displayed.

In a case where the first commodities to be replenished on the commodity shelf is determined, the pick-out assistance device 100 according to the first example embodiment described above can determine the second commodities to be displayed within a prescribed range from the display location of the first commodities. The pick-out assistance device 100 can determine the number of first commodities to be displayed and the number of each of the one or more second commodities to be displayed, and notify the operator of these numbers. Thus, in a case where replenishing the first commodities on the commodity shelf, the operator can replenish or display the second commodities to be displayed within a prescribed range from the display location of the first commodities. Since the display location of the second commodities is within a prescribed range of a first display location, the movement distance for the operator to replenish the second commodities can be suppressed to within the prescribed range. Therefore, it is possible to provide the pick-out assistance device 100 capable of improving the efficiency of the pick-out operation.

The pick-out assistance device 100 includes a processor, a memory, and a storage device as components not illustrated. The storage device stores a computer program in which the processing of the pick-out assistance method according to the present example embodiment is implemented. The processor loads the computer program into the memory from the storage device and executes the computer program. Thus, the processor implements functions of the commodity determination unit 101, the number determination unit 102, and the notification unit 103.

Each of the commodity determination unit 101, the number determination unit 102, and the notification unit 103 may be implemented by dedicated hardware. Some or all of the components of each device may be implemented by a general-purpose or dedicated circuit, a processor, or a combination thereof. These components may be integrated into a single chip or may be configured with a plurality of chips connected via a bus. Some or all of the components of each device may be implemented by a combination of the above-described circuit or the like and a program. As the processor, a central processing unit (CPU), a graphics processing unit (GPU), a field-programmable gate array (FPGA), or the like can be used.

In a case where some or all of the components of the pick-out assistance device 100 are implemented by a plurality of information processing devices, circuits, and the like, a plurality of the information processing apparatuses, circuits, and the like may be disposed in a centralized manner or in a distributed manner. For example, the information processing devices, the circuits, or the like may be implemented in a configuration where each of the components is connected via a communication network, such as a client-server system or a cloud computing system. The function of the pick-out assistance device 100 may be provided in software as a service (SaaS) format.

### Second Example Embodiment

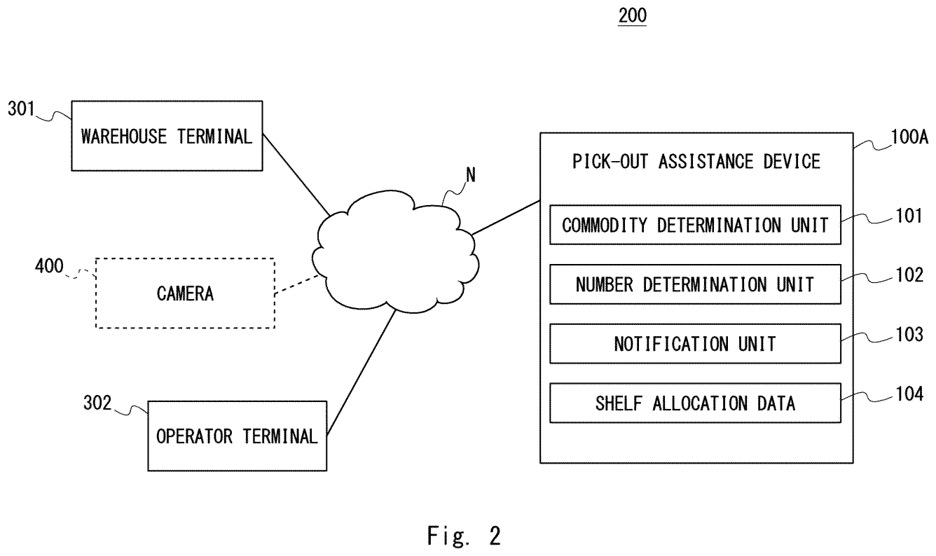

FIG. 2 is a diagram illustrating a configuration of a pick-out assistance system 200 according to a second example embodiment. The pick-out assistance system 200 includes a pick-out assistance device 100A that assists an operator in a pick-out operation and a warehouse terminal 301 and an operator terminal 302 as terminal devices used by the operators. The pick-out assistance device 100A, the warehouse terminal 301, and the operator terminal 302 can communicate with each other via the Internet N. The warehouse terminal 301 is a terminal device used in a warehouse, and the operator terminal 302 is a terminal device carried by the operator. The pick-out assistance system 200 may include a camera 400. The camera 400 is, for example, an in-store camera installed in a store or a camera mounted on a patrol robot that goes around in the store, and captures images over time of the area where the commodities are displayed on the commodity shelf. The camera 400 may be a camera mounted on the operator terminal 302. As illustrated in FIG. 2, the pick-out assistance device 100A includes a commodity determination unit 101, a number determination unit 102, a notification unit 103, and shelf allocation data 104.

The commodity determination unit 101 acquires an image (hereinafter, also referred to as an “acquired image”) of the commodity shelf captured by the camera 400. The commodity determination unit 101 determines the first commodities based on the acquired image.

Specifically, the commodity determination unit 101 first performs image processing on the acquired image, and calculates a “ratio of the number of actually displayed commodities to the number of commodities to be displayed” for the commodities displayed on the commodity shelf.

Specifically, the commodity determination unit 101 performs image processing on the acquired image to detect a vacant location where commodities are not displayed. Next, the commodity determination unit 101 calculates the size of the vacant location based on the number of pixels in the image area corresponding to the vacant location. The commodity determination unit 101 identifies the shelf position of the vacant location on the commodity shelf, and refers to the shelf allocation data 104 (to be described later) to identify the commodities to be displayed at the vacant location and the “number of commodities to be displayed”. Next, the commodity determination unit 101 calculates the “number of actually displayed commodities” based on the size of the vacant location. The commodity determination unit 101 calculates a “ratio of the number of actually displayed commodities to the number of commodities to be displayed”.

The commodity determination unit 101 may perform image recognition processing on commodities in the acquired image, and calculate the number of displayed commodities as the “number of actually displayed commodities”. Next, the commodity determination unit 101 may acquire the “number of commodities to be displayed” by referring to the shelf allocation data 104. The commodity determination unit 101 may calculate a “ratio of the number of actually displayed commodities to the number of commodities to be displayed”. The commodity determination unit 101 may perform the image processing on all the commodities displayed on the commodity shelf and calculate a “ratio of the number of actually displayed commodities to the number of commodities to be displayed” for the commodities displayed on the commodity shelf.

Next, the commodity determination unit 101 determines first commodities based on the calculated “ratio of the number of actually displayed commodities to the number of commodities to be displayed (hereinafter, also simply referred to as “ratio”). Specifically, the commodity determination unit 101 determines, as the first commodities, commodities whose ratio is equal to or less than a prescribed ratio and is the lowest.

The first commodities may be optionally designated by the operator.

Next, the commodity determination unit 101 determines one or more second commodities. For example, the commodity determination unit 101 determines, as the second commodities, commodities to be displayed within a prescribed range from the display location of the first commodities, and the “number of actually displayed commodities” is smaller than the “number of commodities to be displayed”. Specifically, the commodity determination unit 101 performs image processing on the acquired image to detect a vacant location where commodities are not displayed. Next, the commodity determination unit 101 performs image processing on the acquired image, and identifies the shelf position of the vacant location on the commodity shelf. Next, the commodity determination unit 101 refers to the shelf allocation data 104 to determine whether the vacant location is within the prescribed range. Next, in a case where the vacant location is within the prescribed range, the commodity determination unit 101 refers to the shelf allocation data 104 to acquire identification information of commodities to be displayed at the vacant location. Here, the identification information of the commodities includes a commodity name and an identification number.

The commodity determination unit 101 may identify the position of a first commodity in the acquired image, and detect whether there is a vacant location where commodities are not displayed within the prescribed range based on the position of the first commodity in the acquired image, in the acquired image. Here, the “position of the first commodity in the acquired image” indicates, for example, image coordinates at the center of a range in which the first commodities are displayed. Then, in a case where there is a vacant location within the prescribed range, the commodity determination unit 101 may identify commodities displayed in the vacant location by image recognition processing using an image obtained a predetermined time before the acquired image. In a case where there is a vacant location within the prescribed range, the commodity determination unit 101 may perform image recognition processing on an image of a shelf label corresponding to the vacant location in the acquired image, and identify commodities to be displayed in at the vacant location. The shelf label is a label attached to a commodity shelf to display a commodity name. In these cases, the commodity determination unit 101 can determine the second commodities without referring to the shelf allocation data 104.

The commodity determination unit 101 may determine, as the second commodities, commodities whose ratio is equal to or less than the prescribed ratio, the commodities being displayed within a prescribed range from the display location of the first commodities.

The commodity determination unit 101 may refer to the inventory data of the warehouse and exclude commodities not in the warehouse from the candidates for the second commodities. The inventory data is data in which the identification information of the commodities and the number of commodities stored in the warehouse are associated with each other, and may be stored in advance in the pick-out assistance device 100A. Here, the identification information of the commodities includes a commodity name and an identification number.

The commodity determination unit 101 may determine the size of a prescribed range based on the time period during which the operator performs the pick-out operation.

For example, the commodity determination unit 101 may set the prescribed range to be narrower than a predetermined size in a time period during which the number of visitors reaches a maximum. Thus, although the number of types of commodities to be replenished at one time is reduced, a larger number of commodities can be replenished for one type of commodity, and it is possible to prevent stock shortages. On the other hand, the commodity determination unit 101 may set the prescribed range to be wider than a predetermined size in a time period during which the number of visitors is relatively small. Thus, a larger number of types of commodities can be replenished at one time, and the efficiency of the pick-out operation can be improved.

The commodity determination unit 101 may set the prescribed range to be wider than a predetermined size in a time period during which the number of visitors reaches a maximum. Thus, a larger number of types of commodities can be replenished at one time, and it is possible to prevent stock shortages for the larger number of types of commodities.

The number determination unit 102 determines the number of first commodities to be displayed and the number of each of the one or more second commodities to be displayed. Here, the “number of commodities to be displayed” means the number of commodities to be replenished. For example, the number determination unit 102 may determine the number of first commodities to be displayed based on the “number of actually displayed first products” and the “number of first commodities to be displayed” which are calculated by the commodity determination unit 101. The number determination unit 102 may calculate the “number of actually displayed second commodities” by a method similar to that of the commodity determination unit 101, acquire the “number of second commodities to be displayed” with reference to the shelf allocation data 104, and determine the number of second commodities to be displayed based on the “number of actually displayed second commodities” and the “number of second commodities to be displayed”.

The number determination unit 102 may determine the number of first commodities to be displayed and the number of each of the one or more second commodities to be displayed based on the loading capacity of a cart used by the operator to perform the pick-out operation. In a case where there is a plurality of carts to be used for picking out the commodities in a single operation, such as in a case where a plurality of carts are connected to perform the pick-out operation, the number determination unit 102 may determine the number of first commodities to be displayed and the number of each of the one or more second commodities to be displayed based on the number of carts to be used for the single pick-out operation and the loading capacity of the carts.

The number determination unit 102 may determine the number of first commodities to be displayed based on the predicted sales quantity of the first commodities predicted based on the day on which the operator performs a pick-out operation and the number of first commodities actually displayed on the commodity shelf. Similarly, the number determination unit 102 may determine the number of each of the one or more second commodities to be displayed based on the predicted sales quantity of the second commodities predicted based on the day on which the operator performs a pick-out operation and the number of second commodities actually displayed on the commodity shelf. Here, the “predicted sales quantity of the commodities predicted based on the day on which the operator perform a pick-out operation” is, for example, the sales quantity of the commodities in the past such as in the morning, one year ago, or the like, whether the commodities are on special sale, whether the commodities are related to a season event, the sales quantity of the commodities predicted based on the weather condition of the day, or the like.

The notification unit 103 transmits, to the warehouse terminal 301 or the operator terminal 302, the number of first commodities to be displayed and the number of each of the one or more second commodities to be displayed. Note that the notification unit 103 may transmit the acquired images and the number of acquired images to the warehouse terminal 301 or the operator terminal 302. The notification unit 103 may transmit the ratio between the first commodities and the second commodities to the warehouse terminal 301 or the operator terminal 302 instead of the number of acquired images or together with the number of the acquired images.

The shelf allocation data 104 is data in which identification information of commodities, the shelf position of commodities displayed on the commodity shelf, and the number of commodities to be displayed are associated with each other. Here, the identification information of the commodities includes a commodity name and an identification number.

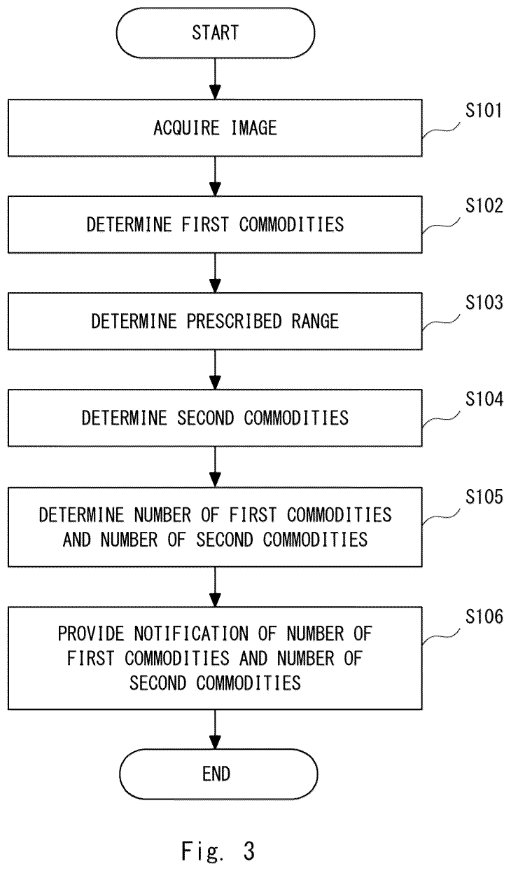

Next, a pick-out assistance method according to the second example embodiment will be described with reference to FIG. 3.

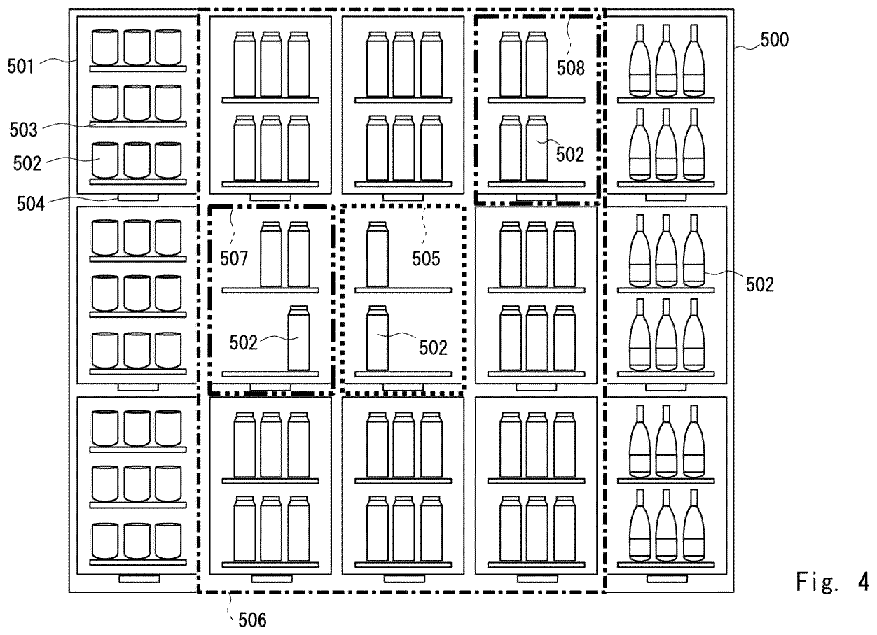

First, the commodity determination unit 101 acquires an image of commodity shelf captured by the camera 400 as an acquired image (step S101). FIG. 4 illustrates an example of an acquired image 500.

In the acquired image 500 illustrated in FIG. 4, the commodity shelf includes a plurality of storage portions 501, and the commodities 502 are displayed in each storage portion 501. Each storage portion 501 further includes one or more shelf panels 503. A shelf label 504 that displays a commodity name of a commodity displayed in each storage portion 501 is attached to each storage portion 501. In the example illustrated in FIG. 4, the commodity shelf includes a total of 15 storage portions 501 arranged in five columns and three rows.

Next, the commodity determination unit 101 determines the first commodities based on the acquired image 500 (step S102). Specifically, the commodity determination unit 101 performs image processing on the acquired image, and calculates a “ratio of the number of actually displayed commodities to the number of commodities to be displayed” for the commodities displayed on the commodity shelf. The commodity determination unit 101 determines, as the first commodities, commodities whose ratio is equal to or less than a prescribed ratio and is the lowest. For example, in the example illustrated in FIG. 4, the ratio of the commodities 502 displayed in the storage portion 501 surrounded by a broken line 505 is the lowest. Thus, the commodity determination unit 101 determines the commodities 502 displayed in the storage portion 501 surrounded by the broken line 505 as the first commodities.

Next, the commodity determination unit 101 determines the size of the prescribed range to determine the second commodities (step S103). In FIG. 4, a prescribed range 506 determined by the commodity determination unit 101 is indicated by a one-dot chain line.

Next, the commodity determination unit 101 determines one or more second commodities to be displayed in the prescribed range 506 from the display location of the first commodities (step S104). Specifically, the commodity determination unit 101 performs image processing on the acquired image, detects a vacant location where commodities are not displayed within the prescribed range 506, and determines the commodities to be displayed at the vacant location as the second commodities. For example, in the example illustrated in FIG. 4, there vacant locations in the storage portions 501 respectively surrounded by two-dot chain lines 507 and 508. Thus, the commodity determination unit 101 determines the commodities 502 displayed in the storage portions 501 respectively surrounded by the two-dot chain lines 507 and 508 as the second commodities.

Next, the number determination unit 102 determines the number of first commodities to be displayed and the number of each of the one or more second commodities to be displayed (step S105). For example, in the example illustrated in FIG. 4, the number determination unit 102 determines that the number of first commodities 502 to be displayed in the storage portion 501 surrounded by the broken line 505 is four, the number of second commodities 502 to be displayed in the storage portion 501 surrounded by the two-dot chain line 507 is three, and the number of second commodities 502 to be displayed in the storage portion 501 surrounded by the two-dot chain line 508 is two.

Next, the notification unit 103 notifies the warehouse terminal 301 and the operator terminal 302 of the number of first commodities to be displayed and the number of each of the one or more second commodities to be displayed, which are determined in step S105 (step S106), and ends the present processing.

In a case where the first commodities to be replenished on the commodity shelf is determined, the pick-out assistance system 200 according to the second example embodiment described above can determine the second commodities to be displayed within a prescribed range from the display location of the first commodities. The pick-out assistance system 200 can determine the number of first commodities to be displayed and the number of each of the one or more second commodities to be displayed, and notify warehouse terminal 301 and the operator terminal 302 of these numbers. Thus, in a case where replenishing the first commodities on the commodity shelf, the operator can replenish or display the second commodities to be displayed within a prescribed range from the display location of the first commodities. Since the display location of the second commodities is within a prescribed range of a first display location, the movement distance for the operator to replenish the second commodities can be suppressed to within the prescribed range. Therefore, it is possible to provide the pick-out assistance system 200 capable of improving the efficiency of the pick-out operation.

The number determination unit 102 determines the number of first commodities to be displayed and the number of each of the one or more second commodities to be displayed based on the loading capacity of the carts used by the operator to perform pick-out operation, and thus it is possible to avoid a situation in which the first commodities and the second commodities do not get on the carts.

The commodity determination unit 101 determines the size of a prescribed range based on the time period during which the operator performs the pick-out operation, and thus it is possible to prevent the stock shortages and improve the efficiency of the pick-out operation.

The number determination unit 102 determines the number of first commodities to be displayed and the number of the second commodities to be displayed based on the predicted sales quantities of the first commodities and the second commodities predicted based on the day on which the operator performs the pick-out operation, and thus it is possible to more effectively prevent stock shortages of the first commodities and the second commodities.

In the above-described example embodiments, the configuration of the hardware has been described, but the present disclosure is not limited thereto. According to the present disclosure, the above-described processing can also be implemented by causing a CPU to execute a computer program.

In the above-described example, the program can be stored using various types of non-transitory computer-readable medium and supplied to a computer. The non-transitory computer-readable media include various types of tangible storage media. Examples of the non-transitory computer-readable media include a magnetic recording medium (for example, a flexible disk, a magnetic tape, or a hard disk drive), a magneto-optical recording medium (for example, a magneto-optical disc), a CD-read only memory (ROM), a CD-R, a CD-R/W, a digital versatile disc (DVD), and a semiconductor memory (for example, a mask ROM, a programmable ROM (PROM), an erasable PROM (EPROM), a flash ROM, or a random access memory (RAM)). The program may be supplied to the computer by various types of transitory computer-readable media. Examples of transitory computer readable media include electrical signals, optical signals, and electromagnetic waves. The transitory computer readable media can supply the programs to the computer via a wired communication path such as an electric wire and an optical fiber or a wireless communication path.

The present disclosure is not limited to the above-described example embodiments, and can be appropriately changed without departing from the gist. The present disclosure may be implemented by appropriately combining the example embodiments.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments. For example, the shelf allocation data 104 may be updated based on an image of a commodity shelf captured at a predetermined timing.

The whole or part of the example embodiments disclosed above can be described as, but not limited to, the following supplementary notes.

### Supplementary Note 1

A pick-out assistance device including:
a commodity determination means for determining one or more second commodities that are different from first commodities and that are displayed within a prescribed range from a display location of the first commodities designated as commodities to be displayed on a commodity shelf;
a number determination means for determining the number of the first commodities to be displayed and the number of each of the one or more second commodities to be displayed; and
a notification means for notifying an operator of the number of the first commodities to be displayed and the number of each of the one or more second commodities to be displayed.

### Supplementary Note 2

The pick-out assistance device according to Supplementary note 1,
in which the number determination means determines the number of the first commodities to be displayed and the number of each of the one or more second commodities to be displayed based on a loading capacity of a cart used by the operator to perform a pick-out operation.

### Supplementary Note 3

The pick-out assistance device according to Supplementary note 1,
in which the commodity determination means determines a size of the prescribed range based on a time period during which the operator performs a pick-out operation.

### Supplementary Note 4

The pick-out assistance device according to Supplementary note 1,
in which the number determination means determines the number of the first commodities to be displayed and the number of each of the one or more second commodities to be displayed based on a predicted sales quantity of the first commodities or the second commodities predicted based on the day on which the operator performs a pick-out operation and the number of the first commodities or the second commodities displayed on the commodity shelf.

### Supplementary Note 5

A pick-out assistance system including:
a pick-out assistance device that assists an operator in a pick-out operation; and
a terminal device that is used by the operator,
in which the pick-out assistance device includes
a commodity determination means for determining one or more second commodities that are different from first commodities and that are displayed within a prescribed range from a display location of the first commodities designated as commodities to be displayed on a commodity shelf,
a number determination means for determining the number of the first commodities to be displayed and the number of each of the one or more second commodities to be displayed, and
a notification means for notifying the terminal device of the number of the first commodities to be displayed and the number of each of the one or more second commodities to be displayed.

### Supplementary Note 6

The pick-out assistance system according to Supplementary note 5,
in which the number determination means determines the number of the first commodities to be displayed and the number of each of the one or more second commodities to be displayed based on a loading capacity of a cart used by the operator to perform the pick-out operation.

### Supplementary Note 7

The pick-out assistance system according to Supplementary note 5,
in which the commodity determination means determines a size of the prescribed range based on a time period during which the operator performs the pick-out operation.

### Supplementary Note 8

The pick-out assistance system according to Supplementary note 5,
in which the number determination means determines the number of the first commodities to be displayed and the number of each of the one or more second commodities to be displayed based on a predicted sales quantity of the first commodities or the second commodities predicted based on the day on which the operator performs the pick-out operation and the number of the first commodities or the second commodities displayed on the commodity shelf.

### Supplementary Note 9

A pick-out assistance method including causing a computer to:
determine one or more second commodities that are different from first commodities and that are displayed within a prescribed range from a display location of the first commodities designated as commodities to be displayed on a commodity shelf;
determine the number of the first commodities to be displayed and the number of each of the one or more second commodities to be displayed; and
notify an operator of the number of the first commodities to be displayed and the number of each of the one or more second commodities to be displayed.

### Supplementary Note 10

The pick-out assistance method according to Supplementary note 9, further including causing the computer to determine the number of the first commodities to be displayed and the number of each of the one or more second commodities to be displayed based on a loading capacity of a cart used by the operator to perform a pick-out operation.

### Supplementary Note 11

The pick-out assistance method according to Supplementary note 9, further including causing the computer to determine a size of the prescribed range based on a time period during which the operator performs a pick-out operation.

### Supplementary Note 12

The pick-out assistance method according to Supplementary note 9, further including causing the computer to determine the number of the first commodities to be displayed and the number of each of the one or more second commodities to be displayed based on a predicted sales quantity of the first commodities or the second commodities predicted based on the day on which the operator performs a pick-out operation and the number of the first commodities or the second commodities displayed on the commodity shelf.

### Supplementary Note 13

A non-transitory computer-readable medium storing a program that causes a computer to execute:
processing of determining one or more second commodities that are different from first commodities and that are displayed within a prescribed range from a display location of the first commodities designated as commodities to be displayed on a commodity shelf;
processing of determining the number of the first commodities to be displayed and the number of each of the one or more second commodities to be displayed; and
processing of notifying an operator of the number of the first commodities to be displayed and the number of each of the one or more second commodities to be displayed.

### Supplementary note 14

The non-transitory computer-readable medium according to Supplementary note 13, storing the program that causes the computer to further execute processing of determining the number of the first commodities to be displayed and the number of each of the one or more second commodities to be displayed based on a loading capacity of a cart used by the operator to perform a pick-out operation.

### Supplementary note 15

The non-transitory computer-readable medium according to Supplementary note 13, storing the program that causes the computer to further execute processing of determining a size of the prescribed range based on a time period during which the operator performs a pick-out operation.

### Supplementary note 16

The non-transitory computer-readable medium according to Supplementary note 13, storing the program that causes the computer to further execute processing of determining the number of the first commodities to be displayed and the number of each of the one or more second commodities to be displayed based on a predicted sales quantity of the first commodities or the second commodities predicted based on the day on which the operator performs a pick-out operation and the number of the first commodities or the second commodities displayed on the commodity shelf.

Reference Signs List

| 100, 100A | PICK-OUT ASSISTANCE DEVICE |
|---|---|
| 101 | COMMODITY DETERMINATION UNIT (COMMODITY |
| | DETERMINATION MEANS) |
| 102 | NUMBER DTERMINATION UNIT (NUMBER |
| | DTERMINATION MEANS) |
| 103 | NOTIFICATION UNIT (NOTIFICATION MEANS) |
| 104 | SHELF ALLOCATION DATA |
| 200 | PICK-OUT ASSISTANCE SYSTEM |
| 301 | WAREHOUSE TERMINAL (TERMINAL DEVICE) |
| 302 | OPERATOR TERMINAL (TERMINAL DEVICE) |
| 400 | CAMERA |
| 500 | ACQUIRED IMAGE |

What is claimed is:

1. A pick-out assistance device comprising:
a memory storing instructions; and
one or more processors configured to execute the instructions to:
determine one or more second commodities that are different from first commodities and that are displayed within a prescribed range from a display location of the first commodities designated as commodities to be displayed on a commodity shelf;
determine the number of the first commodities to be displayed and the number of each of the one or more second commodities to be displayed; and
notify an operator of the number of the first commodities to be displayed and the number of each of the one or more second commodities to be displayed.

2. The pick-out assistance device according to claim 1,
wherein the one or more processors configured to execute the instructions to determine the number of the first commodities to be displayed and the number of each of the one or more second commodities to be displayed based on a loading capacity of a cart used by the operator to perform a pick-out operation.

3. The pick-out assistance device according to claim 1,
wherein the one or more processors configured to execute the instructions to determine a size of the prescribed range based on a time period during which the operator performs a pick-out operation.

4. The pick-out assistance device according to claim 1,
wherein the one or more processors configured to execute the instructions to determine the number of the first commodities to be displayed and the number of each of the one or more second commodities to be displayed based on a predicted sales quantity of the first commodities or the second commodities predicted based on the day on which the operator performs a pick-out operation and the number of the first commodities or the second commodities displayed on the commodity shelf.

5-8. (canceled)

9. A pick-out assistance method comprising causing a computer to:
determine one or more second commodities that are different from first commodities and that are displayed within a prescribed range from a display location of the first commodities designated as commodities to be displayed on a commodity shelf;
determine the number of the first commodities to be displayed and the number of each of the one or more second commodities to be displayed; and
notify an operator of the number of the first commodities to be displayed and the number of each of the one or more second commodities to be displayed.

10. The pick-out assistance method according to claim 9, further comprising causing the computer to determine the number of the first commodities to be displayed and the number of each of the one or more second commodities to be displayed based on a loading capacity of a cart used by the operator to perform a pick-out operation.

11. The pick-out assistance method according to claim 9, further comprising causing the computer to determine a size of the prescribed range based on a time period during which the operator performs a pick-out operation.

12. The pick-out assistance method according to claim 9, further comprising causing the computer to determine the number of the first commodities to be displayed and the number of each of the one or more second commodities to be displayed based on a predicted sales quantity of the first commodities or the second commodities predicted based on the day on which the operator performs a pick-out operation and the number of the first commodities or the second commodities displayed on the commodity shelf.

13. A non-transitory computer-readable medium storing a program that causes a computer to execute:
processing of determining one or more second commodities that are different from first commodities and that are displayed within a prescribed range from a display location of the first commodities designated as commodities to be displayed on a commodity shelf;
processing of determining the number of the first commodities to be displayed and the number of each of the one or more second commodities to be displayed; and
processing of notifying an operator of the number of the first commodities to be displayed and the number of each of the one or more second commodities to be displayed.

14. The non-transitory computer-readable medium according to claim 13, storing the program that causes the computer to further execute processing of determining the number of the first commodities to be displayed and the number of each of the one or more second commodities to be displayed based on a loading capacity of a cart used by the operator to perform a pick-out operation.

15. The non-transitory computer-readable medium according to claim 13, storing the program that causes the computer to further execute processing of determining a size of the prescribed range based on a time period during which the operator performs a pick-out operation.

16. The non-transitory computer-readable medium according to claim 13, storing the program that causes the computer to further execute processing of determining the number of the first commodities to be displayed and the number of each of the one or more second commodities to be displayed based on a predicted sales quantity of the first commodities or the second commodities predicted based on the day on which the operator performs a pick-out operation and the number of the first commodities or the second commodities displayed on the commodity shelf.
